(19) United States
(12) Patent Application Publication
(10) Pub. No.: US 2014/0324575 A1
(43) Pub. Date: Oct. 30, 2014

(54) METHODS AND SYSTEMS FOR TRACKING CONSUMERS WITHOUT SERVER-SIDE PROFILING

(71) Applicant: AppNexus Inc., New York, NY (US)

(72) Inventors: Matthew Haies, New York, NY (US); Charles B. O'Kelley, New York, NY (US); David Wainberg, New York, NY (US)

(21) Appl. No.: 14/266,035

(22) Filed: Apr. 30, 2014

Related U.S. Application Data
(60) Provisional application No. 61/817,649, filed on Apr. 30, 2013.

(51) Int. Cl. G06Q 30/02

(52) U.S. Cl. CPC G06Q 30/0251
USPC 705/14.49

(57) ABSTRACT

Systems and methods for implementing a do-not-profile program for online advertising participants. An advertisement serving system receives a first request for an advertisement to be served to a device of a user, wherein the first request comprises an advertisement call to a compliant domain. The advertisement serving system provides to the user device based on the first request (i) a first advertisement and (ii) information associated with the first advertisement for storage local to the user device. A second request for an advertisement to be served to the user device is received, wherein the second request comprises an advertisement call to the compliant domain and the information associated with the first advertisement, and a second advertisement to serve to the user device is determined based on the information. Other information uniquely identifying the user or the user device is not stored by the advertisement serving system.

### CROSS-REFERENCE TO RELATED APPLICATION

This application claims priority to and the benefit of U.S. Provisional Patent Application No. 61/817,649, filed on Apr. 30, 2013, and entitled “Methods and Systems for Tracking Consumers without Server-Side Profiling,” the entirety of which is incorporated by reference herein.

### BACKGROUND

The present disclosure relates generally to user tracking and, more particularly, to systems and methods for tracking and advertising to users without collecting user identifying data across unrelated sites.

Consumer trust is a major issue in online advertising but, at the same time, much of the content made available online requires advertising revenue. Consumers often do not understand what data is being collected from them or how that data is used, but many would not pay the actual cost of content if it were not funded or subsidized by advertising. Even without additional standards and regulation, consumers are actively blocking ads and deleting cookies. Avoiding this issue will not rebuild consumer trust and will push the Internet toward a system of paywalls and content farming. Ideally, consumers should be comfortable with online advertising and how their online behavior is being tracked across the web. Further, the needs of the core commercial participants in the online advertising ecosystem, i.e., marketers and publishers, should be satisfied. To date, these concerns have not been adequately addressed.

### BRIEF SUMMARY

Systems and methods are presented for tracking consumers without profiling users or storing uniquely identifying information server-side. The disclosed technique, referred to herein as the “Do Not Profile” (DNP) program, is a solution to the privacy issues that have plagued the online advertising industry for more than a decade. By providing much-needed transparency and prohibiting the most misunderstood commercial activity, DNP is a consumer-centric bridge between users' expectations and commercial practices. DNP protects targeting and measurement to allow online advertising to thrive for marketers and publishers.

In one aspect, a computer-implemented method includes receiving, by an advertisement serving system, a first request for an advertisement to be served to a device of a user, wherein the first request comprises an advertisement call to a compliant domain; providing, by the advertisement serving system, to the user device based on the first request (i) a first advertisement and (ii) information associated with the first advertisement for storage local to the user device; receiving, by the advertisement serving system, a second request for an advertisement to be served to the user device, wherein the second request comprises an advertisement call to the compliant domain and the information associated with the first advertisement; determining a second advertisement to serve to the user device based on the information associated with the first advertisement; and providing, by the advertisement serving system, to the user device based on the second request (i) the second advertisement and (ii) information associated with the second advertisement for storage local to the user device, wherein information uniquely identifying the user and information uniquely identifying the user device is not stored by the advertisement serving system.

Various implementations can include one or more of the following features. The information associated with the first advertisement is provided as an HTTP header. The information associated with the first advertisement comprises history information. The history information comprises a unique identifier associated with the first advertisement. The history information comprises a timestamp associated with the providing of the first advertisement. The second request further comprises history information associated with one or more advertisements previously served to the user device from only the compliant domain. Determining a second advertisement to serve to the user device comprises performing at least one of frequency capping and sequencing based on the history information associated with the one or more advertisements previously served to the user device from only the compliant domain. The information associated with the first advertisement comprises marketing information. The marketing information comprises a unique identifier associated with a set of domains. The marketing information comprises a remarketing segment assigned to the user. Determining a second advertisement to serve to the user device comprises selecting the second advertisement based at least in part on the remarketing segment assigned to the user.

In another aspect, a system includes an advertisement serving system configured to perform operations comprising: receiving a first request for an advertisement to be served to a device of a user, wherein the first request comprises an advertisement call to a compliant domain; providing to the user device based on the first request (i) a first advertisement and (ii) information associated with the first advertisement for storage on the user device; receiving, by the advertisement serving system, a second request for an advertisement to be served to the user device, wherein the second request comprises an advertisement call to the compliant domain and the information associated with the first advertisement; determining a second advertisement to serve to the user device based on the information associated with the first advertisement; and providing to the user device based on the second request (i) the second advertisement and (ii) information associated with the second advertisement for storage on the user device, wherein information uniquely identifying the user and information uniquely identifying the user device is not stored by the advertisement serving system.

Various implementations can include one or more of the following features. The information associated with the first advertisement is provided as an HTTP header. The information associated with the first advertisement comprises history information. The history information comprises a unique identifier associated with the first advertisement. The history information comprises a timestamp associated with the providing of the first advertisement. The second request further comprises history information associated with one or more advertisements previously served to the user device from only the compliant domain. Determining a second advertisement to serve to the user device comprises performing at least one of frequency capping and sequencing based on the history information associated with the one or more advertisements previously served to the user device from only the compliant domain. The information associated with the first advertisement comprises marketing information. The marketing information comprises a unique identifier associated with a set of domains. The marketing information comprises a remarketing segment assigned to the user. Determining a second advertisement to serve to the user device comprises selecting the second advertisement based at least in part on the remarketing segment assigned to the user.

In another aspect, a computer-implemented method includes sending, to an advertisement serving system, a first request for an advertisement to be served to a device of a user, wherein the first request comprises an advertisement call to a compliant domain; receiving from the advertisement serving system based on the first request (i) a first advertisement and (ii) information associated with the first advertisement; upon verifying that the first advertisement is served by a compliant domain, storing the information associated with the first advertisement local to the user device; sending, to the advertisement serving system, a second request for an advertisement to be served to the user device, wherein the second request comprises an advertisement call to the compliant domain and the information associated with the first advertisement; receiving from the advertisement serving system based on the second request (i) a second advertisement and (ii) information associated with the second advertisement; and upon verifying that the second advertisement is served by a compliant domain, storing the information associated with the second advertisement local to the user device, wherein information uniquely identifying the user and information uniquely identifying the user device is not stored by the advertisement serving system.

In one implementation, the information associated with the first advertisement comprises the compliant domain, and verifying that the first advertisement is served by a compliant domain comprises determining that the compliant domain exists in a list of verified compliant domains.

In another aspect, a system includes one or more computers programmed to perform operations comprising: sending, to an advertisement serving system, a first request for an advertisement to be served to a device of a user, wherein the first request comprises an advertisement call to a compliant domain; receiving from the advertisement serving system based on the first request (i) a first advertisement and (ii) information associated with the first advertisement; upon verifying that the first advertisement is served by a compliant domain, storing the information associated with the first advertisement local to the user device; sending, to the advertisement serving system, a second request for an advertisement to be served to the user device, wherein the second request comprises an advertisement call to the compliant domain and the information associated with the first advertisement; receiving from the advertisement serving system based on the second request (i) a second advertisement and (ii) information associated with the second advertisement; and upon verifying that the second advertisement is served by a compliant domain, storing the information associated with the second advertisement local to the user device, wherein information uniquely identifying the user and information uniquely identifying the user device is not stored by the advertisement serving system.

In one implementation, the information associated with the first advertisement comprises the compliant domain, and verifying that the first advertisement is served by a compliant domain comprises determining that the compliant domain exists in a list of verified compliant domains.

The details of one or more implementations of the subject matter described in the present specification are set forth in the accompanying drawings and the description below. Other features, aspects, and advantages of the subject matter will become apparent from the description, the drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 is a diagram illustrating a communication flow between a browser and ad serving system according to an implementation.

FIG. 2 is a flowchart illustrating a method for advertising without server-side profiling according to an implementation.

FIG. 3 is a flowchart illustrating a method for advertising without server-side profiling according to an implementation.

### DETAILED DESCRIPTION

Described herein in various implementations are systems and accompanying methods for providing a “Do Not Profile” (DNP) program for advertisers and consumers. The Do Not Profile program is a privacy-based, consumer-centric solution in the spirit of Privacy by Design. It is a proactive effort that provides true transparency and choice to consumers, and creates appropriate incentives and accountability for the commercial participants in the ecosystem.

### Overview

The Do Not Profile program prohibits the collection and usage of data across unrelated sites (“profiling”). Profiling is viewed by many as “creepy” and causes consumers to lose trust in the entire advertising economy. Consumers expect that when they intentionally engage with a site that the site will use this relationship to personalize content and advertising for them. However, many have argued that users do not expect information collected by that site to be used by other parties, outside that direct relationship, to influence advertising and content on other sites. In line with these expectations, DNP participants can use data gathered from sites that they own and operate (O&O) for two purposes: to target ads for their own brand and/or to personalize ads and content on O&O sites. Permitted use of data is as shown in Table 1.

TABLE 1

| | Activity | | | |
|---|---|---|---|---|
| | Target | Target other | Target own | |
| | own brand | brand | brand on | Target other |
| | on O&O | on O&O | third-party | brand on third- |
| Source of Data | property | property | property | party property |
| O&O inventory | Yes | Yes | Yes | No |
| Third-party | No | No | No | No |
| inventory | | | | |
| Opted-out user | No | No | No | No |

Accordingly, if a user (e.g., an impression consumer) sees an ad, there can be three reasons why the user saw it: (1) targeting based on context or aggregated data (e.g., site targeting, placement targeting, geo targeting); (2) targeting by a brand based on data collected in connection with the user's direct relationship with that brand (e.g., eBay data used to show the user an ad for eBay); and/or (3) targeting based on data collected by the site the user is visiting (e.g., the user's nytimes.com profile says that the user is a sports enthusiast, and the user is shown an ad for Yankees tickets).

In some implementations, advertisements provided by Do Not Profile participants have an explicit icon or other indicator that links to information that explains why the ad was shown. This proactively addresses the “creepy” factor for the user by providing transparency into every ad that is shown.

In one implementation, the Do Not Profile program enables “profile-free advertising,” which eliminates the need for unique identifiers for impression consumers, browsers, user devices, and so on in the ad-serving process. Participating ad companies agree not to utilize cookies, statistical IDs or similar user-associated mechanisms (IP addresses would be used only to provide functionality that is fundamental for the consumer's user experience and the operation of the system as discussed herein). A minimum set of necessary information is stored client-side, and only ad companies participating in the DNP program are able to access that information to serve advertising.

### Functionality

User Experience Functionality and System Integrity Functionality

User Experience Functionality consists of (i) recency, (ii) frequency, (iii) sequencing and (iv) geo-targeting. A user who encounters the same ad or series of ads on multiple occasions over a relatively short period of time is likely to be annoyed by the experience. In addition, that user will likely have her opinion of the particular marketer diminished by the experience, thus lowering the marketer's brand value. A user also may be annoyed, or at least confused, by an ad irrelevant to her general location. User Experience Functionality should maintain a user's expectations about online advertising and should not be objectionable to the user.

System Integrity Functionality entails the prevention of fraudulent activity. Such functionality is intended to eliminate the unjust enrichment of a population of bad actors, which enrichment comes at the expense of the rest of the participants in the online ecosystem, including (directly or indirectly) consumers. System Integrity Functionality should also not violate a user's expectations about online advertising and should not be objectionable to the user.

Marketer Effectiveness Functionality

Marketer Effectiveness Functionality includes two elements that marketers have repeatedly indicated as crucial to their online activities—conversion attribution and retargeting based on a first-party relationship. As this functionality would result in ad technology companies receiving additional data, in some implementations such companies can be required to register as DNP participants and submit to an annual compliance audit.

In addition, because retargeting, even based on a first-party relationship, is not clearly understood by the average consumer, transparency is needed to build consumer comfort with the practice. Accordingly, DNP participants can be required to include an icon on each retargeted ad that discloses to the consumer that such ad was served because of past interactions with that marketer and to provide consumers an easy mechanism to opt out of retargeting either for the particular marketer or universally.

### Compliance and Enforcement

In one implementation, DNP participants can be required to go through an annual audit to be treated as DNP-compliant, although in some implementations, only companies that offer Marketer Effectiveness Functionality are required to undergo such an audit. Web browsers can be configured to support advertising functionality for third-party calls only to registered DNP-compliant companies. In addition, browsers can be configured to not support any persistent storage (e.g., cookies) for unregistered third parties, and can take all available measures to minimize browser identifiability (e.g., restrict the User Agent header to a simple major version string).

A DNP program participant that intentionally fails to comply with the no-profiling requirement can be deemed to have engaged in deceptive practices. While both the browser companies and the auditing companies can provide a policing function, other agencies can provide enforcement authority (e.g., the Federal Trade Commission in the United States).

### An Appropriate and Sustainable Balance

The Do Not Profile program is strikes an appropriate balance among all the constituent stakeholders. Consumers receive necessary transparency and control and are free from the “creepy” profiling that diminishes their trust of online advertising and ad-supported content. Marketers retain the ability to market to their customers through display advertising, with appropriate measurement to ensure effectiveness. Indirectly, they benefit from increased consumer trust through improved brand value and user engagement. Publishers retain the ability to personalize advertising and content on their owned and operated sites. The importance of contextual relevance and quality content is increased, which will increase revenue for some publishers and decrease revenue for others.

Advertising networks continue to be important as intermediaries in the advertising ecosystem, but they will not be able to use behavioral profiling as a source of relevance or competitive differentiation. This will be disruptive for some companies, but most major ad networks have direct relationships with publishers and advertisers and will not be impacted. Ad technology companies have an increased compliance burden, but continue to be the trusted foundation of the online advertising industry. As media companies cannot bundle their consumer profiles into the ad server, the exit opportunities for ad technology companies may be more limited.

Interaction with do not Track

Do Not Profile is compatible with the proposed working W3C standard for a Do Not Track header. One possible behavior is that all browsers set “Do Not Track” by default, and that all ad technology companies implement Do Not Profile as their interpretation of what this means. In essence, the two proposals are attempting to achieve similar goals with different means. Were all ad technology companies to adopt DNP, the Do Not Track header would not be needed. Similarly, if all browsers were to set Do Not Track by default, the various constituencies would still need to define a mechanism to implement profile-free advertising like Do Not Profile.

### Technical Overview

The intent of the Do Not Profile functionality is to reduce or eliminate the ability for advertising companies to create behavioral profiles of consumers while allowing for effective marketing and site monetization. Described below is the technical framework to implement DNP within a browser (e.g., Mozilla, Internet Explorer, etc.) and an ad serving platform (e.g., DoubleClick, AppNexus, etc.).

Profile-Free Ad Technology

In one implementation, the DNP program allows ad technology companies (ATCs) to provide advertisement serving systems that can target ads to the most relevant sites and placements, provide frequency capping and sequencing, and measure performance of campaigns—all without creating any server-side identifier or profile of the user or the browser. Advertisement serving systems can include ad servers, ad exchanges, online advertising platforms and transaction managers, ad auction platforms, data storage/analysis systems, ad broker systems, and/or any combination of the foregoing.

To effectively target and measure ad performance, ATCs need to know which ads (e.g., based on a campaign ID and creative ID) that a browser has seen. This allows frequency capping, so the browser doesn't see the same ad again and again. This information can be added to a browser cookie without attaching any identifying information. However, given the opacity of cookies, this is difficult to demonstrate to the consumer.

### DEFINITIONS

Market Identifier (MID): Marketers can have multiple domains that represent the same underlying brand (for instance, BMW uses bmwusa.com in the US and bmw.at in Austria). To allow the browser to connect all of these domains together, the marketer can register for a globally-unique identifier (e.g., “bmw”) that is used to send data to and from the browser.

Ad Identifier (AdID): Each advertisement can have a unique integer identifier assigned by the ATC. This identifier can permanently reference a particular ad creative (e.g., the exact HTML, JavaScript, images, Flash, etc.) sent to the browser, including all of its components. Identifiers can be capped (e.g., maximum 2̂30) to prevent abuse by creating a new AdID per browser.

Transaction Identifier (TxnID): Every time an ad is served, the ad server can provide reporting based on a marketer's delivery criteria and associate this to a success event (e.g., a click, conversion, lead, etc.) for measurement purposes. To facilitate this, the ATC can create a 64-bit transaction ID to send with each delivered ad. The transaction ID can be used only at the time of conversion on the marketer's site, so that it cannot provide information for ad delivery.

Remarketing Segments (SegID): Marketers can establish a limited number of remarketing segments (e.g., up to 32, up to 64, up to 128, etc.) to assign to particular users. These segments can have well-defined, consistent meanings and be transparent to the consumer. For instance, [ebay:1] can represent a frequent eBay seller, while [ebay:7] can represent a eBay customer that has not bid on an item recently.

DNP-Compliant Serving Domain (ATCDomain): An industry group or other entity can provide a machine-readable list of companies and/or domains that are compliant with the DNP program. A user's browser can update this list on a regular basis. Each DNP-compliant company can register one or more domains (i.e., “compliant domains”) that are used for ad serving, and ad extensions should only be enabled for these domains. Compliant domains do not profile users, browsers, or user devices in providing advertising functionality as described herein.

Cookie Crumbs

In one implementation, browsers are configured to not send cookies to all third-party domains. Instead, a persistent storage mechanism with limited functionality is used to manage interactions with DNP-compliant ad companies. As these are abbreviated versions of a cookie, they are referred to herein as “crumbs.”

To implement crumb functionality, a user's browser creates a new client-side storage object for crumbs. The user can see what information the browser is storing and clear these crumbs in much the same way the user clears cookies. The browser can discourage the user from clearing crumbs, however, as they are transparent and used by DNP-compliant companies that have completed a full audit.

There are two types of crumbs: a history crumb and a segmentation crumb. The history crumb includes history information that is used to track which ads a particular user has seen recently. In one implementation, the format of each line of the history crumb is as follows:

ATCDomain,MID,Timestamp,AdID,TxnID

The history crumb can store every ad seen by a user (e.g., served to a user device) over a particular time limit (e.g., in the past 14 days, 30 days, 60 days, and so on). This crumb can be modified by the ATCDomain in a third-party context. The timestamp can represent the time that the associated creative was served to the user, the time that the user received the associated creative, the time that the crumb is stored on the user's machine, or other time indicator.

The segmentation crumb includes marketing information that can be used to track which remarketing segments a particular user has been added to. In some implementations, this crumb is only able to be modified when the user is browsing one of the marketer's registered domains (as associated with the MID). The format of each line of the segmentation crumb can be as follows:

ATCDomain,MID,SegID,Timestamp

The timestamps can represent the time that the associated creative was served to the user, the time that the user received the associated creative, the time that the crumb is stored on the user's machine, or other time indicator.

Advertising Extensions to the HTTP Protocol

In one implementation, Do Not Profile has no effect on the HTTP protocol unless an HTTP request is sent to a DNP-compliant serving domain. In such a case, DNP adds two new headers to the HTTP request, one for each crumb type, and two parallel headers to the HTTP response. In other implementations, however, only one header type or a combination of header formats can be used.

History Request Header

Lines of the crumbs file that match the ATCDomain of the HTTP request are included in the history header. This gives the ATC enough information to do frequency capping and sequencing. In some implementations, the transaction ID is only sent if the primary domain of the page matches the MID (implying that this is a measurement or attribution call). The browser can limit the number of history rows that it sends. If it does, the browser can send the most recent rows first. One example format of the history header is as follows:

X-Ad-History-Crumb: Timestamp,AdID[,TxnID]; . . .

The fields of the history header can match those in the corresponding crumb entry.

Segmentation Request Header

Lines of the crumbs file that match the ATCDomain of the HTTP request are included in the segmentation header. This gives the ATC enough information to do limited remarketing. One example format of the segmentation header is as follows:

X-Ad-Segmentation-Crumb: MID,SegId,Timestamp; . . .

The fields of the history header can match those in the corresponding crumb entry.

Ad Delivery Header

To add history information, the ATC can add a header to the HTTP response requesting a new line in the history file. In some instances this can only be performed for calls to the ATC registered serving domain. The timestamp can be validated to ensure it has not been manipulated to add additional information (in other words, the server doesn't get N bits of additional arbitrary data).

In one implementation, if the browser uses any segmentation information to target the ad, the browser must include the segment ID in the history call. This can trigger a browser overlay on the ad, a privacy notification in the toolbar, or other user information. The segment used should match the MID, although it is not necessary to verify this in real-time. One example format of the ad delivery header is as follows:

X-Ad-Delivery: ATCDomain,MID,AdId,TxnID,Timestamp[,SegID]

Crumb storage is supported by the user's browser, as specified above. In addition, the browser includes a function to support segmentation from marketer sites. In one implementation, this is a JavaScript function defined as follows:

setSegmentCrumb(MID,ATCDomain,[SegId, . . . ])

To manage segmentation information, a marketer can add JavaScript to pages on its site to add segment data. This call can be made on an opt-in or opt-out basis. The setSegmentCrumb function verifies that the MID is valid, that the primary browser URL is the marketer's registered domain, and that the ATCDomain is valid. If any of these checks fails, no action is taken. If all three checks succeed, the browser can add or replace a line in the associated segmentation crumb with the information provided in the function arguments. No data is sent to the ATC when segmentation is configured.

Advertising Preference Panel

In one implementation, the user's browser includes a new preference panel specifically for advertising. This preference panel allows the user to clear ad history (effectively clearing the history crumb) and to browse the remarketing data that is currently set in the segmentation crumb. The remarketing data store can provide sufficient information for the browser to provide a short description of each segment and a link to the marketer's site for more information.

Example Transactions

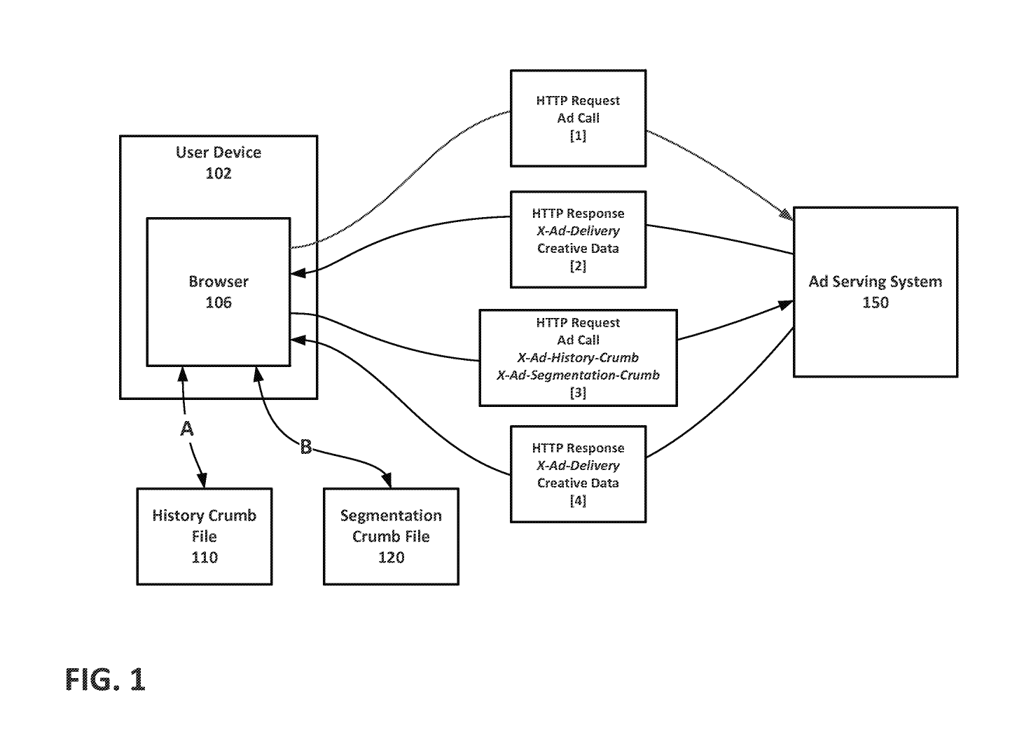

Referring now to FIG. 1, for a page view having no marketing segments, a example transaction is as follows. Initially, a browser 106 on a user device 102 loads a website (e.g., http://contentwebsite.com), which includes an ad call to an ad serving domain for a DNP-compliant ATC (e.g., http://i.dnpads.com) (HTTP Request [1]) via ad serving system 150. The browser loads the ad serving domain with no cookies in the request (as it is a third-party domain). In this example, the ATC returns a creative for BMW (e.g., AdID=21212, MID=“bmw”) and appends a delivery header to the response (HTTP Response [2]) as follows:

X-Ad-Delivery: dnpads.com,bmw,21212,987654321,1367220507

The browser 106 parses the response and adds an identical line (or other format maintaining the data) to the history crumb file 110 that is stored local to the user device 102 (e.g., on the user device itself, on a local storage medium, and so on) (Step A).

At some point in the user's browsing, the user might load a webpage that causes the user to be assigned to a remarketing segment. For example, continuing the example above, the browser loads http://bmwusa.com and, after a few pages (and potentially an opt-in), the site calls the browser function setSegmentCrumb(‘bmw’,‘dnpads.com’,[3]). The browser checks that the MID (i.e., “bmw”) is mapped to the primary domain bmwusa.com, that dnpads.com is a valid DNP-compliant ATC, and that 3 is a valid segment ID. Upon determining that all fields are acceptable, the browser adds a new line to the segmentation crumb file 120 as follows (Step B):

dnpads.com,bmw,3,1367220713

Later, the browser loads http://contentwebsite.com again, which triggers another ad call to the same DNP-compliant ATC (HTTP Request [3]). The browser loads http://i.dnpads.com and includes two additional headers in the HTTP request based on information existing in the history crumb file 110 and segmentation crumb file 120. In this case, the transaction ID is not appended to the history crumb header because the user is not on the marketer's domain.

X-Ad-History-Crumb: 1367220507,21212

X-Ad-Segmentation-Crumb: bmw,3,1367220713

The ATC can determine a different advertisement creative to serve to the user using, for example, frequency capping and/or sequencing based on the history crumb data. The ATC can also serve a BMW ad (e.g., AdID=91717) because the user is now in a BMW segment and, in this case, appends the segment ID to notify the browser that segmentation data was used in targeting. The response (HTTP Response [4]) thus includes the following header:

X-Ad-Delivery: dnpads.com,bmw,91717,987654321,1367220815,3

The browser parses this response and adds a line to the history crumb file 110.

### Example Methods

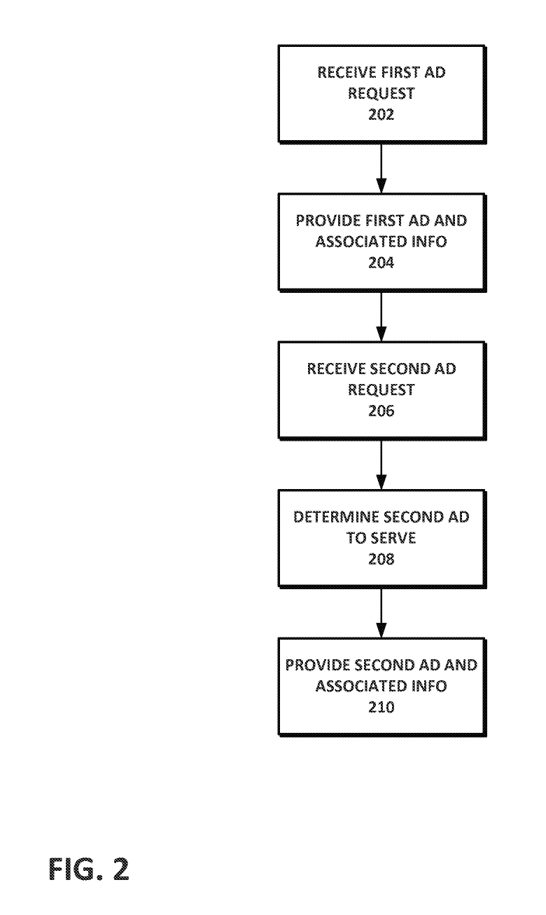

Referring to FIG. 2, in one implementation a method for providing a do-not-profile program includes the following steps. In STEP 202, an advertisement serving system receives a first request for an advertisement to be served to a user device. The first request can include an ad call to a compliant domain. Based on the first request, the ad serving system provides to the user device, in STEP 204, a first advertisement creative and information associated with the creative (e.g., history and/or marketing information such as that described above) for storage local to the user device. In STEP 206, the ad serving system receives a second request for an ad to be served to the user device. For example, the user may return to the original website which has the same DNP-compliant ATC. Thus, the second request includes an ad call to the compliant domain as well as the information associated with the first creative (e.g., history/segmentation crumb entry). Based on this information, the ad serving system can determine that a different ad should be served to the user device (STEP 208), whether on account of frequency capping, recency capping, sequencing, an assigned marketing segment, or otherwise. Then, based on the second request, the ad serving system provides to the user device (i) the second advertisement and (ii) information associated with the second advertisement (e.g., history and/or marketing information) for storage local to the user device (STEP 210). No information that uniquely identifies the user, the user device, or the user's browser is stored by the ad serving system.

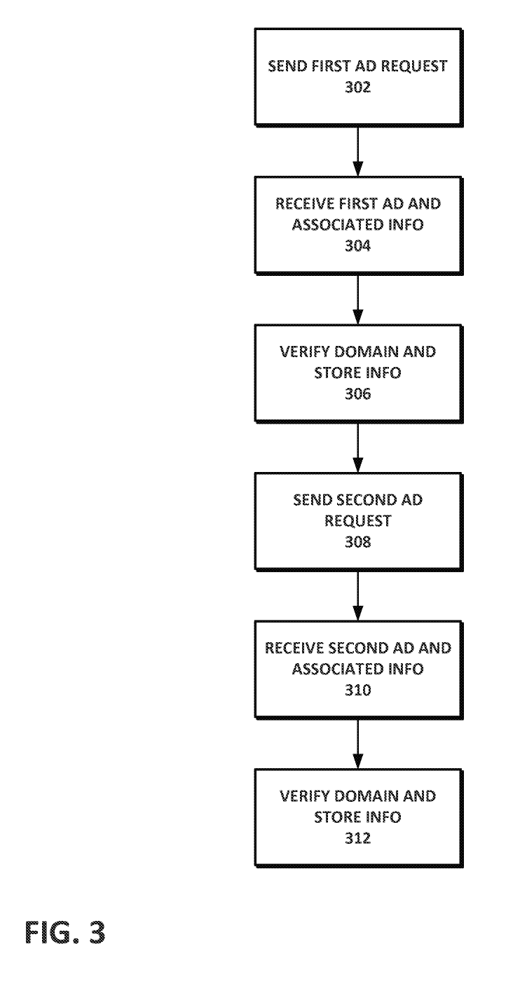

Referring now to FIG. 3, in another implementation a method for providing a do-not-profile program includes the following steps. In STEP 302, a first request is sent to an advertisement serving system (e.g., from a browser on a user device) for an ad to be served to a user device. The first request can include an ad call to a compliant domain. Based on the first request, (i) a first advertisement creative and (ii) information associated with the creative (e.g., history and/or marketing information) is received from the ad serving system (STEP 304). Verification is performed to ensure that the creative was served from a DNP-compliant domain and, if verified, the creative information is stored local to the user device (STEP 306). In STEP 308, a second request for an ad to be served to the user device is sent to the ad serving system. The second request can include an ad call to the same compliant domain and along with the information associated with the first creative (e.g., history/segmentation crumb entry). Based on the second request, in STEP 310, (i) a second creative and (ii) information associated with the second creative is received from the ad serving system. Verification is again performed to ensure that the second creative was served from a DNP-compliant domain and, if verified, the second creative information is then stored local to the user device (STEP 312). No information that uniquely identifies the user, the user device, or the user's browser is stored by the ad serving system.

### Alternatives

The implementations described herein provide sufficient capability to allow an ad technology company to operate without any unique identifier for a user, browser, or device and to store all user-specific information on the client-side. Note that, instead of using crumbs, this protocol can be instead implemented with cookies or other forms of user storage. A system-wide (e.g., operating-system based) implementation of the history crumb that integrates into the default browser and/or other internet-capable applications can be implemented. Ad calls from the browser will update the history crumb as described above, and ad calls from apps can call an API function that updates the history crumb. ATCs can register with the operating system to gain access to history. Marketers and MIDs can be associated with apps as well as domains. Further, in one implementation, an app store can include the ability for a marketer to access the history crumb and assess which transaction ID was most likely to have influenced the install of a particular app.

### System Implementations

Implementations of the system can use appropriate hardware or software; for example, the system can execute on a system capable of running an operating system such as the Microsoft Windows® operating systems, the Apple OS X® operating systems, the Apple iOS® platform, the Google Android™ platform, the Linux® operating system and other variants of UNIX® operating systems, and the like.

Some or all of the functionality described herein can be implemented in software and/or hardware on a user's device 102. A user device 102 can include, but is not limited to, a smart phone, smart watch, smart glasses, tablet computer, portable computer, television, gaming device, music player, mobile telephone, laptop, palmtop, smart or dumb terminal, network computer, personal digital assistant, wireless device, information appliance, workstation, minicomputer, mainframe computer, or other computing device, that is operated as a general purpose computer or a special purpose hardware device that can execute the functionality described herein. The software, for example, can be implemented on a general purpose computing device in the form of a computer including a processing unit, a system memory, and a system bus that couples various system components including the system memory to the processing unit.

Additionally or alternatively, some or all of the functionality can be performed remotely, in the cloud, or via software-as-a-service. For example, as described above, certain functions can be performed on one or more remote backend servers or other devices, as described above, that communicate with the user device 102. The remote functionality can execute on server class computers that have sufficient memory, data storage, and processing power and that run a server class operating system (e.g., Oracle® Solaris®, GNU/Linux®, and the Microsoft® Windows® family of operating systems).

The system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application, implemented in a suitable programming language or framework.

Method steps of the techniques described herein can be performed by one or more programmable processors executing one or more computer programs to perform functions by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

In various implementations, a user device 102 includes a web browser, native application, or both, that facilitates execution of the functionality described herein. A web browser allows the device to request a web page or other downloadable program, applet, or document (e.g., from the backend server(s) or other server, such as a web server) with a web page request. One example of a web page is a data file that includes computer executable or interpretable information, graphics, sound, text, and/or video, that can be displayed, executed, played, processed, streamed, and/or stored and that can contain links, or pointers, to other web pages. In one implementation, a user of the device manually requests a web page from the server. Alternatively, the device automatically makes requests with the web browser. Examples of commercially available web browser software include Microsoft® Internet Explorer®, Mozilla® Firefox®, and Apple® Safari®.

In some implementations, the user device 102 includes client software. The client software provides functionality to the device that provides for the implementation and execution of the features described herein. The client software can be implemented in various forms, for example, it can be in the form of a native application, web page, widget, and/or Java, JavaScript, .Net, Silverlight, Flash, and/or other applet or plug-in that is downloaded to the device and runs in conjunction with the web browser. The client software and the web browser can be part of a single client-server interface; for example, the client software can be implemented as a plug-in to the web browser or to another framework or operating system. Other suitable client software architecture, including but not limited to widget frameworks and applet technology can also be employed with the client software.

A communications network can connect the user devices 102 with one or more remote servers. The communication can take place over media such as standard telephone lines, LAN or WAN links (e.g., T1, T3, 56 kb, X.25), broadband connections (ISDN, Frame Relay, ATM), wireless links (802.11 (Wi-Fi), Bluetooth, GSM, CDMA, etc.), for example. Other communication media are possible. The network can carry TCP/IP protocol communications, and HTTP/HTTPS requests made by a web browser, and the connection between the user device 102 and servers can be communicated over such TCP/IP networks. Other communication protocols are possible.

The system can also be practiced in distributed computing environments where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems such as those mentioned above, and that operate on one or more computers having hardware such as that described herein.

In some cases, relational or other structured databases can provide such functionality, for example, as a database management system which stores data for processing. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The terms and expressions employed herein are used as terms and expressions of description and not of limitation, and there is no intention, in the use of such terms and expressions, of excluding any equivalents of the features shown and described or portions thereof. In addition, having described certain implementations in the present disclosure, it will be apparent to those of ordinary skill in the art that other implementations incorporating the concepts disclosed herein can be used without departing from the spirit and scope of the invention. The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method comprising:
receiving, by an advertisement serving system, a first request for an advertisement to be served to a device of a user, wherein the first request comprises an advertisement call to a compliant domain;
providing, by the advertisement serving system, to the user device based on the first request (i) a first advertisement and (ii) information associated with the first advertisement for storage local to the user device;
receiving, by the advertisement serving system, a second request for an advertisement to be served to the user device, wherein the second request comprises an advertisement call to the compliant domain and the information associated with the first advertisement;
determining a second advertisement to serve to the user device based on the information associated with the first advertisement; and
providing, by the advertisement serving system, to the user device based on the second request (i) the second advertisement and (ii) information associated with the second advertisement for storage local to the user device,
wherein information uniquely identifying the user and information uniquely identifying the user device is not stored by the advertisement serving system.

2. The method of claim 1, wherein the information associated with the first advertisement is provided as an HTTP header.

3. The method of claim 1, wherein the information associated with the first advertisement comprises history information.

4. The method of claim 3, wherein the history information comprises a unique identifier associated with the first advertisement.

5. The method of claim 3, wherein the history information comprises a timestamp associated with the providing of the first advertisement.

6. The method of claim 3, wherein the second request further comprises history information associated with one or more advertisements previously served to the user device from only the compliant domain.

7. The method of claim 6, wherein determining a second advertisement to serve to the user device comprises performing at least one of frequency capping and sequencing based on the history information associated with the one or more advertisements previously served to the user device from only the compliant domain.

8. The method of claim 1, wherein the information associated with the first advertisement comprises marketing information.

9. The method of claim 8, wherein the marketing information comprises a unique identifier associated with a set of domains.

10. The method of claim 8, wherein the marketing information comprises a remarketing segment assigned to the user.

11. The method of claim 10, wherein determining a second advertisement to serve to the user device comprises selecting the second advertisement based at least in part on the remarketing segment assigned to the user.

12. A system comprising:
an advertisement serving system configured to perform operations comprising:
receiving a first request for an advertisement to be served to a device of a user,
wherein the first request comprises an advertisement call to a compliant domain;
providing to the user device based on the first request (i) a first advertisement and (ii) information associated with the first advertisement for storage on the user device;
receiving, by the advertisement serving system, a second request for an advertisement to be served to the user device, wherein the second request comprises an advertisement call to the compliant domain and the information associated with the first advertisement;
determining a second advertisement to serve to the user device based on the information associated with the first advertisement; and
providing to the user device based on the second request (i) the second advertisement and (ii) information associated with the second advertisement for storage on the user device,
wherein information uniquely identifying the user and information uniquely identifying the user device is not stored by the advertisement serving system.

13. The system of claim 12, wherein the information associated with the first advertisement is provided as an HTTP header.

14. The system of claim 12, wherein the information associated with the first advertisement comprises history information.

15. The system of claim 14, wherein the history information comprises a unique identifier associated with the first advertisement.

16. The system of claim 14, wherein the history information comprises a timestamp associated with the providing of the first advertisement.

17. The system of claim 14, wherein the second request further comprises history information associated with one or more advertisements previously served to the user device from only the compliant domain.

18. The system of claim 17, wherein determining a second advertisement to serve to the user device comprises performing at least one of frequency capping and sequencing based on the history information associated with the one or more advertisements previously served to the user device from only the compliant domain.

19. The system of claim 12, wherein the information associated with the first advertisement comprises marketing information.

20. The system of claim 19, wherein the marketing information comprises a unique identifier associated with a set of domains.

21. The system of claim 19, wherein the marketing information comprises a remarketing segment assigned to the user.

22. The system of claim 21, wherein determining a second advertisement to serve to the user device comprises selecting the second advertisement based at least in part on the remarketing segment assigned to the user.

23. A computer-implemented method comprising:
sending, to an advertisement serving system, a first request for an advertisement to be served to a device of a user, wherein the first request comprises an advertisement call to a compliant domain;
receiving from the advertisement serving system based on the first request (i) a first advertisement and (ii) information associated with the first advertisement;
upon verifying that the first advertisement is served by a compliant domain, storing the information associated with the first advertisement local to the user device;
sending, to the advertisement serving system, a second request for an advertisement to be served to the user device, wherein the second request comprises an advertisement call to the compliant domain and the information associated with the first advertisement;
receiving from the advertisement serving system based on the second request (i) a second advertisement and (ii) information associated with the second advertisement; and
upon verifying that the second advertisement is served by a compliant domain, storing the information associated with the second advertisement local to the user device,
wherein information uniquely identifying the user and information uniquely identifying the user device is not stored by the advertisement serving system.

24. The method of claim 23, wherein the information associated with the first advertisement comprises the compliant domain, and wherein verifying that the first advertisement is served by a compliant domain comprises determining that the compliant domain exists in a list of verified compliant domains.

25. A system comprising:
one or more computers programmed to perform operations comprising:
sending, to an advertisement serving system, a first request for an advertisement to be served to a device of a user, wherein the first request comprises an advertisement call to a compliant domain;
receiving from the advertisement serving system based on the first request (i) a first advertisement and (ii) information associated with the first advertisement;
upon verifying that the first advertisement is served by a compliant domain, storing the information associated with the first advertisement local to the user device;
sending, to the advertisement serving system, a second request for an advertisement to be served to the user device, wherein the second request comprises an advertisement call to the compliant domain and the information associated with the first advertisement;
receiving from the advertisement serving system based on the second request (i) a second advertisement and (ii) information associated with the second advertisement; and
upon verifying that the second advertisement is served by a compliant domain, storing the information associated with the second advertisement local to the user device,
wherein information uniquely identifying the user and information uniquely identifying the user device is not stored by the advertisement serving system.

26. The system of claim 25, wherein the information associated with the first advertisement comprises the compliant domain, and wherein verifying that the first advertisement is served by a compliant domain comprises determining that the compliant domain exists in a list of verified compliant domains.
